(19) United States
(12) Patent Application Publication
(10) Pub. No.: US 2025/0110207 A1
(43) Pub. Date: Apr. 3, 2025

(54) TWO-DIMENSIONAL PULSE INTEGRATION METHOD

(71) Applicant: SALUS MARINE SYSTEMS CO., LTD., Daejeon (KR)

(72) Inventor: Byung Doo KIM, Daejeon (KR)

(73) Assignee: SALUS MARINE SYSTEMS CO., LTD., Daejeon (KR)

(21) Appl. No.: 18/833,300

(22) PCT Filed: Nov. 29, 2022
(86) PCT No.: PCT/KR2022/019095

§ 371 Date: Jul. 25, 2024

(30) Foreign Application Priority Data
Feb. 15, 2022 (KR) 10-2022-0019781

(51) Int. Cl. G01S 7/32

(52) U.S. Cl. CPC G01S 7/32

(57) ABSTRACT

The present invention relates to a pulse integration method for a radar signal, wherein the two-dimensional pulse integration method according to the present invention comprises: a reference data extraction step (S10) for extracting m×N pieces of reference data for m consecutive azimuth range bins including the p-th range bin for the p-th pulse integration of a received radar image signal; a data arrangement step (S20) for arranging the extracted m×N pieces of reference data in ascending order of size; a substitution step (S30) for substituting, among the arranged reference data, all the pieces of data after the k-th piece with the k-th reference data value; and an integration step (S40) for adding up the post-substitution reference data values according to [Mathematical equation 3] (where N represents the number of divisions into which azimuth angle is divided, and m represents the number of range bins included in pulse integration).

$$y = \frac{{\sum }_{j = 1}^{k} {x}_{j} + ( mN - k ) {x}_{k}}{mN} \qquad [ Mathematical equation 3 ]$$

### TECHNICAL BACKGROUND

The present invention relates to a method of processing radar signals, and more particularly to pulse integration methods.

### RELATED ART

A Vessel Traffic Service System is a system that collects information from various sensors such as radar, meteorological apparatus, CCTV, information from the Automatic Identification System, and information of the maritime environment collected from various communication devices. It enables safe and effective maritime control by providing real-time maritime information and ship information to controllers at the maritime control center.

There are three types of radars operated at VTS centers in major domestic ports, and most of them use magnetron-based non-coherent radar, so maintenance and repair costs are increasing every year. Considering long-term cost efficiency, research incorporating the latest IT technology is underway, but there is not much research on the radar signal processing technique used in the VTS radar system operated at major domestic ports, and research for non-coherent signal processing technique is rare.

Among several radar signal processing techniques, the representative signal processing techniques used to improve the signal to noise ratio are the pulse integration method and the CFAR threshold method. The pulse integration method is a signal processing method that obtains the average of discretized values of the same ranged cell positions in N video signals input from the detector, such as Square Law Detector. The pulse integration method can be classified into two types: coherent pulse integration or pre-detection integration and non-coherent pulse integration or post-detection integration depending on the signal processing process.

Radar systems using the non-coherent method require SNR improvement through signal processing such as pulse integration or CFAR threshold techniques, because signal processing must be done using only the magnitude of output signal of the detector.

FIG. 1 is a conceptual diagram of a general non-coherent pulse integration method. The non-coherent pulse integration method generates Pulse Integration Signal DX+1,1, . . . , DX+1,M by combing pulse trains surrounding a pulse train ACPX+1 at a specific azimuth. N pulse trains ACP1, . . . . ACPX, ACPX+1, . . . , ACPN are input into M range bins SX,1 . . . , SX,M along the azimuth angle of radar. The non-coherent pulse integration method can reduce interference and spike noise signals by including pulse signals with peripheral azimuth to a specific pulse integral signal.

FIG. 2 and FIG. 3 are examples of the pulse integration method, with FIG. 2 showing the video integration method and FIG. 3 showing the censored video integration method. The video integration method is a method for deriving the arithmetic sum of samples located at the same distance as an integral value, and is expressed as [Equation 1].

$$y = \frac{{\sum }_{j = 1}^{k} {x}_{j}}{N} \qquad [ Equation 1 ]$$

The censored video integration method is a method of performing integration by clamping signals over a certain sized signal in order to reduce the influence of spike noise. Signals in the same range bin in N pulse trains are sorted in ascending order of size. After sorting, the kth order and subsequent signals are resized to the kth order signals, and can be expressed as [Equation 2].

$$y = \frac{{\sum }_{j = 1}^{k} {x}_{j} + ( N - k ) {x}_{k}}{N} \qquad [ Equation 2 ]$$

Since the above conventional pulse integration methods perform pulse integration for one range bin, there is a problem in that the SNR cannot be lowered to the desired level if there is not enough data.

[Article] Park Dong-hwa, Jeong Se-young, Choi Kwan-beom, and Kim Byeong-du. Pulse integration technique for VTS applications. The Journal of Korea Information and Communications Society. Korean Society of Communications, 2014.07., Vol.39C, No.07, 521-527.

### SUMMARY OF THE INVENTION

### Technical Issues

The problem that the present invention wishes to solve is to provide a pulse integration method that can improve the signal-to-noise ratio and spike noise removal ability compared to the conventional pulse integration method for one range bin.

### Technical Solutions

The two-dimensional pulse integration method according to the present invention comprises a reference data extraction step of extracting m×N pieces of reference data for each azimuth of m consecutive range bins, including the pth range bin, for the pth pulse integral of the received radar signal; a data sorting step of sorting the extracted m×N reference data in ascending order of size; a replacement step of replacing all reference data after the kth reference data among the sorted reference data with the kth reference data value; and an integration step of summing all the reference data values after a replacement step according to [Equation 3], wherein N is the number of azimuth divisions and m is the number of range bins included in the pulse integration.

$$y = \frac{{\sum }_{j = 1}^{k} {x}_{j} + ( mN - k ) {x}_{k}}{mN} \qquad [ Equation 3 ]$$

### Effects of the Invention

The two-dimensional pulse integration method according to the present invention can increase SNR and improve noise spike removal ability compared to the conventional one-dimensional pulse integration method. In addition, if the two-dimensional pulse integration section is divided and the optimal value of each divided pulse integration result is adopted, target resolution can be significantly improved.

### BRIEF DESCRIPTION OF THE DRAWINGS

FIG. 1 shows a conceptual diagram of a general non-coherent pulse integration method.

FIG. 2 shows a conceptual diagram of the video integration method

FIG. 3 shows a conceptual diagram of the censored video integration method.

FIG. 4 shows a conceptual diagram of the first embodiment of the two-dimensional pulse integration method according to the present invention.

FIG. 5 shows a flowchart of the first embodiment of the two-dimensional pulse integration method according to the present invention.

FIG. 6 shows a conceptual diagram of a second embodiment of the two-dimensional pulse integration method according to the present invention.

FIG. 7 shows a flowchart of a second embodiment of the two-dimensional pulse integration method according to the present invention.

FIG. 8 shows a conceptual diagram of a third embodiment of the two-dimensional pulse integration method according to the present invention.

FIG. 9 shows a flowchart of a third embodiment of the two-dimensional pulse integration method according to the present invention.

FIG. 10 and FIG. 11 show radar raw signals generated for separate and adjacent targets, respectively, to compare the results of the conventional one-dimensional pulse integration method and the two-dimensional pulse integration method according to the present invention.

FIG. 12 shows a graph of pulse integration results for separated targets processed by two conventional one-dimensional pulse integration methods and three two-dimensional pulse integration methods according to the present invention.

FIG. 13 is a table showing the mean and standard deviation of the results of FIG. 11

FIG. 14 shows a graph of pulse integration results processed by two conventional one-dimensional pulse integration methods and three two-dimensional pulse integration methods according to the present invention for adjacent targets.

FIG. 15 is a table showing the mean and standard deviation of the results of FIG. 13

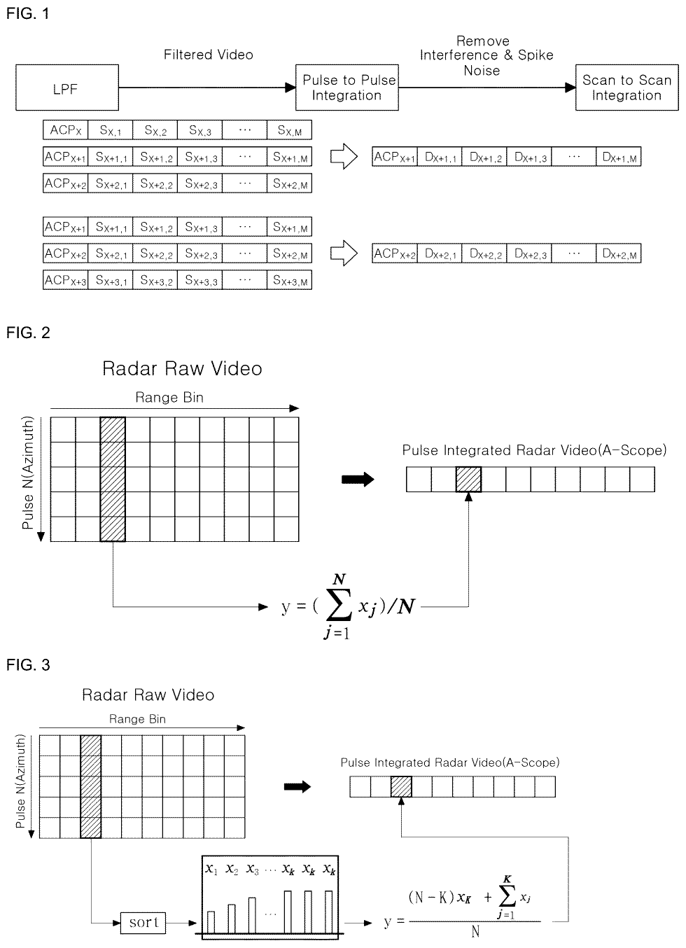

### DETAILED DESCRIPTION

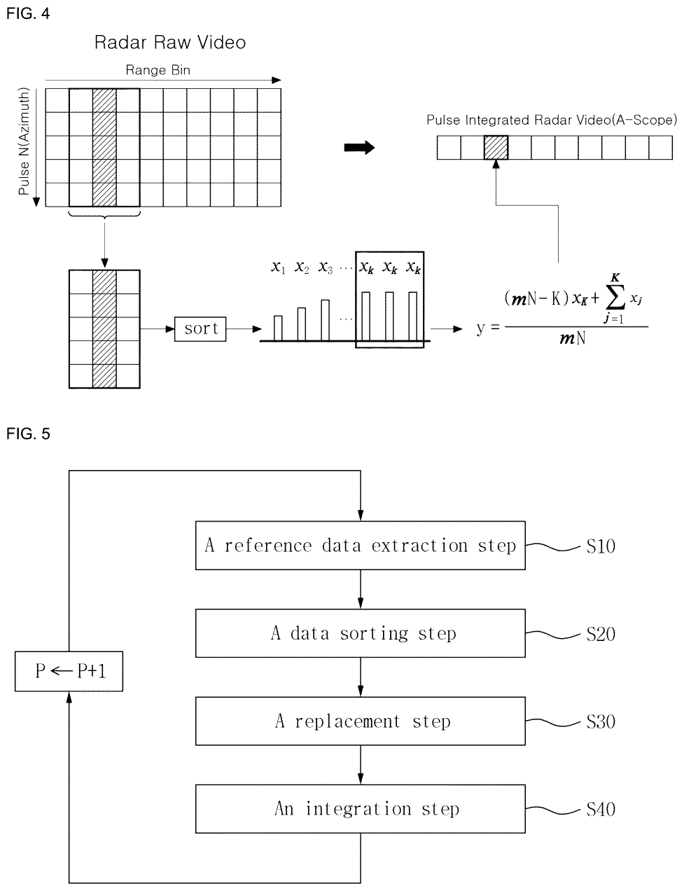

FIG. 4 is a conceptual diagram of a first embodiment of a two-dimensional pulse integration method according to the present invention. The two-dimensional pulse integration method according to the present invention can be performed in a sort of censored manner for a plurality of range bins consecutively before and after, including the range bin where pulse integration is performed. That is, the reference data formed in two dimensions for the azimuth and range bin are sorted in ascending order of size, and pulse integration is performed on the kth order and subsequent data as the same as the kth order data. This can be expressed mathematically as [Equation 3] below, wherein m is the number of range bins included in pulse integration.

$$y = \frac{{\sum }_{j = 1}^{k} {x}_{j} + ( mN - k ) {x}_{k}}{mN} \qquad [ Equation 3 ]$$

FIG. 5 is a flowchart of a first embodiment of the two-dimensional pulse integration method according to the present invention. The first embodiment of the two-dimensional pulse integration method according to the present invention comprises a reference data extraction step S10 of extracting m×N pieces of reference data for each azimuth of m consecutive range bins, including the pth range bin, for the pth pulse integral of the received radar signal; a data sorting step S20 of sorting the extracted m×N reference data in ascending order of size; a replacement step of replacing all reference data after the kth reference data among the sorted reference data with the kth reference data value; and an integration step of summing all the reference data values after a replacement step according to [Equation 3].

After the above reference data extraction step S10 to integration step S40 has cycled through one cycle, the p value is increased by 1 and the above reference data extraction step S10 to integration step S40 are repeated again to cover the entire range bin to derive the corresponding pulse integration result which is so called an A-scope.

Such as when it is p=1 or p=R that means no previous data or no subsequent data, any before or after data is excluded in the pulse integration. For example, as shown in FIG. 4, one Range Bin is selected before and after the pth Range Bin, if m=3, then at p=1, reference data corresponding to the first and second Range Bin can be included in the pulse integration and the reference data corresponding to the R-1th and Rth Range Bins can be included in the pulse integration at p=R.

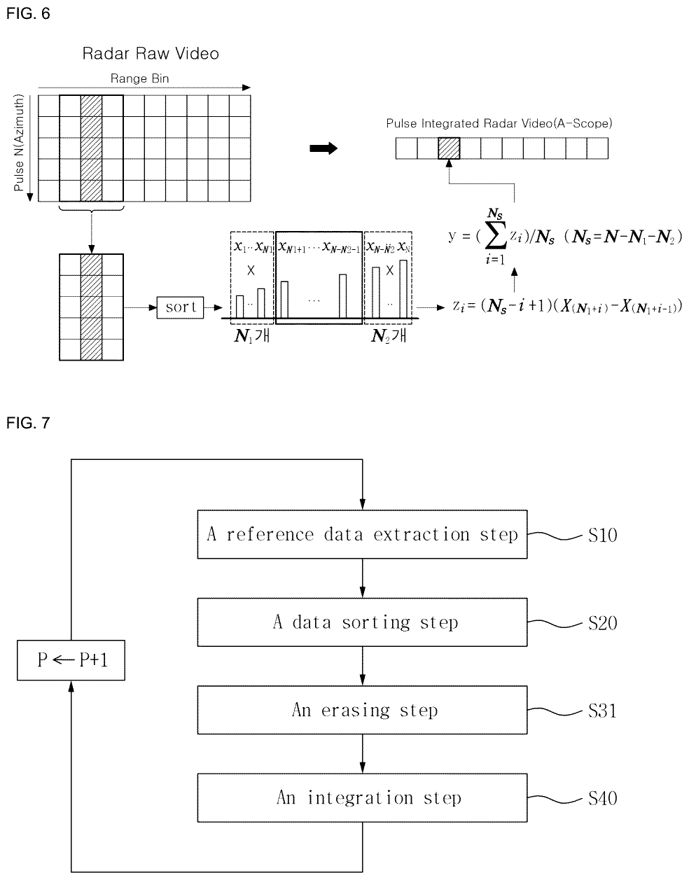

FIG. 6 is a conceptual diagram of a second embodiment of the two-dimensional pulse integration method according to the present invention, and FIG. 7 is a flow chart thereof. The selection of reference data in the second embodiment of the present invention is the same as that in the first embodiment. That is, for the pth pulse integration of the received radar signal, the pth Range Bin is included and pulse integration is performed on m×N reference data for each azimuth of m consecutive range bins. In the second embodiment, in order to reduce the influence of extreme data, data below the first predetermined sequence and above the second predetermined sequence is not considered in the pulse integration when m×N pieces of reference data are sorted in ascending order of size. For example, among reference data sorted in ascending order, data up to N1 from the front and N2 from the back are not included in the pulse integration. This can be expressed mathematically as [Equation 5] below, wherein N1 is the number of data to be excluded from the front when mx N reference data are sorted in ascending order of size, and N2 is the number of data to be excluded from the back. N1, N2 can be set as a design variable).

$${Z}_{j} = ( {N}_{s} - j + 1 ) ( {X}_{N 1 + J} - {X}_{N 1 + j - 1} ) , {N}_{s} = N - N 1 - N 2 \qquad [ Equation 4 ]$$

$$y = \frac{{\sum }_{j = 1}^{Ns} {Z}_{j}}{{N}_{s}} \qquad [ Equation 5 ]$$

Therefore, the second embodiment of the two-dimensional pulse integration method according to the present invention comprises a reference data extraction step S10 of extracting m×N pieces of reference data for each azimuth of m consecutive range bins, including the pth range bin for the pth pulse integral of the received radar signal; a data sorting step S20 in which the extracted m×N reference data are sorted in ascending order of size, an erasing step S31 of erasing the first N1 reference data and the last N2 reference data among the sorted reference data, and an integration step S40 of summing the remained reference data values after erasing are performed according to [Equation 4] and [Equation 5] above.

After the above referenced data extraction step S10 to integration step S40 completes one cycle, the p value is increased by 1 and the above referenced data extraction step S10 to integration step S40 is repeated again to correspond to the entire range bin to derive the pulse integration result. At this time, processing in cases there is no previous data or no subsequent data these are p=1 or p=R, is the same as the first embodiment.

The first and second embodiments of the two-dimensional pulse integration method according to the present invention are more efficient in removing SNR and noise spikes, compared to the existing method of integrating one range bin, but it is observed that there is not such high effect in improving the distance resolution of adjacent targets. Accordingly, the present inventor solved this problem by separating the reference data group and selecting the result that allows distance resolution among each pulse integration result.

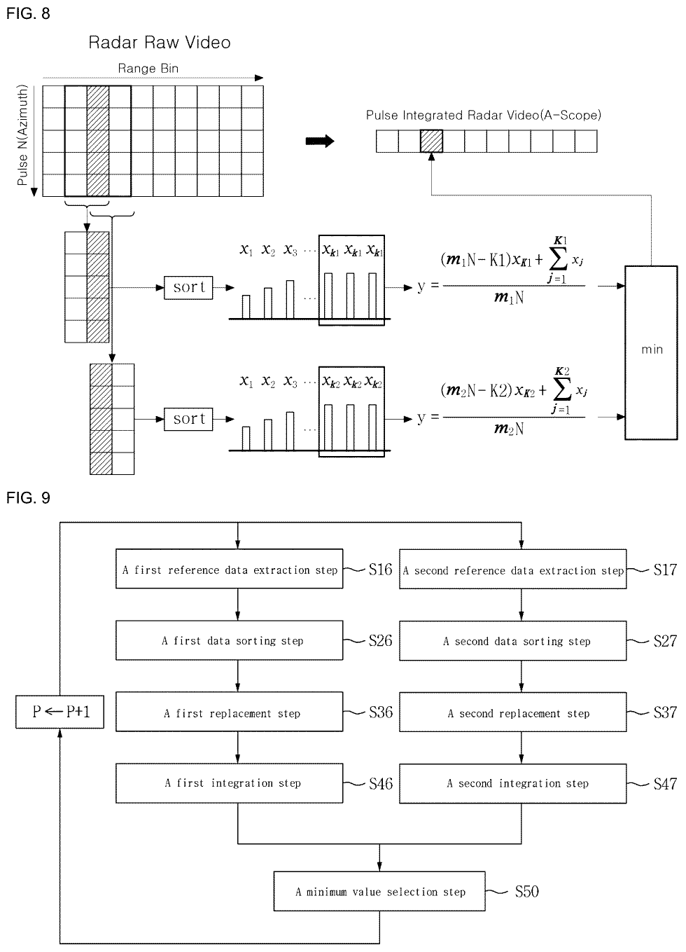

FIG. 8 is a conceptual diagram of a third embodiment of the two-dimensional pulse integration method according to the present invention, and FIG. 9 is a flow chart thereof. The third embodiment of the two-dimensional pulse integration method according to the present invention performs the first pulse integration over m1×N reference data for each azimuth of m1 range bins that include the pth range bin and are continuous up to the pth range bin, and the second pulse integration over m2×N reference data for each azimuth of m2 range bins that include the pth range bin and start from the pth range bin, and the smaller value among the results of the first and second pulse integration is selected as the final pulse integration result.

As for the first and second pulse integration methods, the case of the first or second embodiment described above may be adopted, and like the first embodiment, all reference data after the kth sequence are replaced with the kth reference data value. The pulse integral value when adopting the substitution method is as follows [Equation 6], wherein m1 is the number of range bins included in the first pulse integration, m2 is the number of range bins included in the second pulse integration, k1 is the sequence of reference data to clamp subsequent reference data to the same value in the first pulse integration, and k2 is the sequence of reference data to clamp subsequent reference data to the same value in the second pulse integration.

$$y = min [ \frac{{\sum }_{j = 1}^{k 1} {x}_{j} + ( {m}_{1} N - k 1 ) {x}_{k 1}}{{m}_{1} N} , \frac{{\sum }_{j = 1}^{k 2} {x}_{j} + ( {m}_{2} N - k 2 ) {x}_{k 2}}{{m}_{2} N} ] \qquad [ Equation 6 ]$$

The third embodiment of the two-dimensional pulse integration method according to the present invention comprises a first reference data extraction step S16 of extracting m1×N reference data for each azimuth of m1 consecutive range bins that include the pth range bin and are continuous up to the pth range bin for the pth pulse integral of the received radar signal, a first data sorting step S26 of sorting the extracted m1×N first reference data in ascending order of size, a first replacement step S36 in which all reference data after the k1th reference data among the sorted reference data are replaced with the k1th reference data value, a first integration step S46 of summing all the reference data values after replacement, a second reference data extraction step S17 of extracting m2×N reference data for each azimuth of m2 consecutive range bins that include the pth range bin and continuous from the pth range bin, a second data sorting step S27 of sorting the extracted m2×N second reference data in ascending order of size, a second replacement step S37 in which all reference data after the k2th reference data among the sorted reference data are replaced with the k2th reference data value, a second integration step S47 of summing all the reference data values after replacement, and a minimum value selection step S50 that adopts the smaller value between the results of the first integration step S46 and the second integration step S47.

When the first reference data extraction step S16 to the first integration step S46, the second reference data extraction step S17 to the second integration step S47, and the minimum value selection step S50 are performed in one cycle, the p value is increased by 1 and the above cycle is repeated again to derive the pulse integration result corresponding to the entire range bin. At this time, processing in cases there is no previous data or no subsequent data these are p=1 or p=R, is the same as the first embodiment.

The phenomenon of the third embodiment of the two-dimensional pulse integration method according to the present invention having increased resolution compared to the first or second embodiments is noticeable when the target is adjacent.

The reason is that if integration is performed on the entire reference data while the targets are adjacent, the target signal is greatly affective so the signal between the two targets will increase.

This can be confirmed in the experiment below. In order to suppress the signal between the two targets as much as possible, pulse integration is performed by distinguishing before and after based on the pth reference data where pulse integration is performed, and the smaller value is adopted.

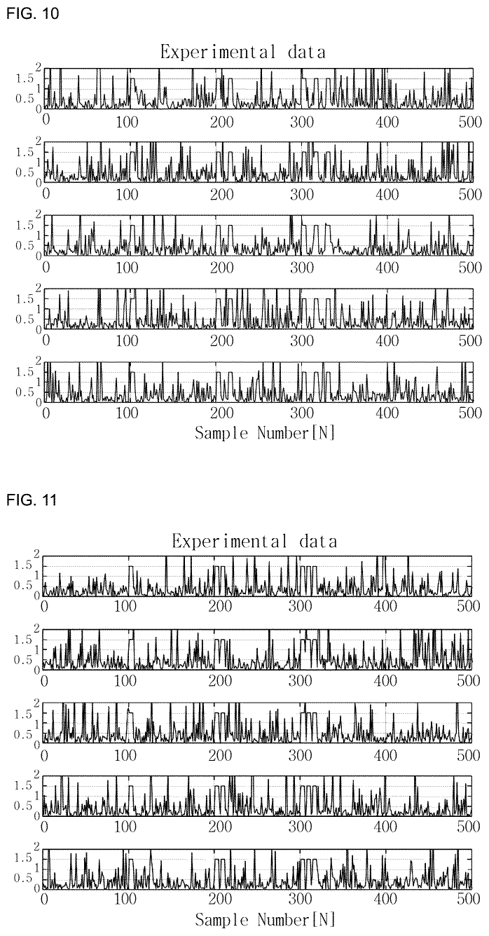

FIG. 10 and FIG. 11 are raw radar signals generated for separate and adjacent targets to compare the results of the conventional one-dimensional pulse integration method and the two-dimensional pulse integration method according to the present invention. It can be seen that the target signals displayed in FIG. 11 are larger and adjacent to each other compared to FIG. 10, wherein the five waveform diagrams shown in FIG. 10 and FIG. 11 represent five consecutive pulses that is N=5 to be integrated.

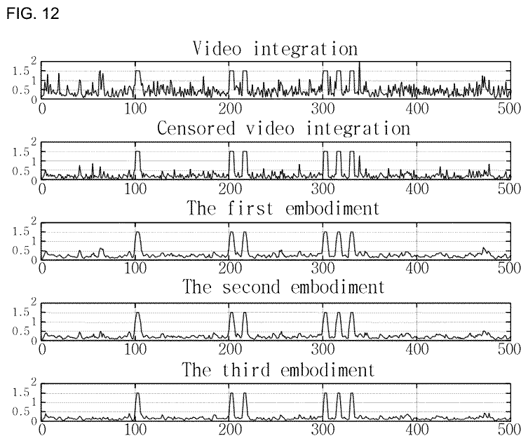

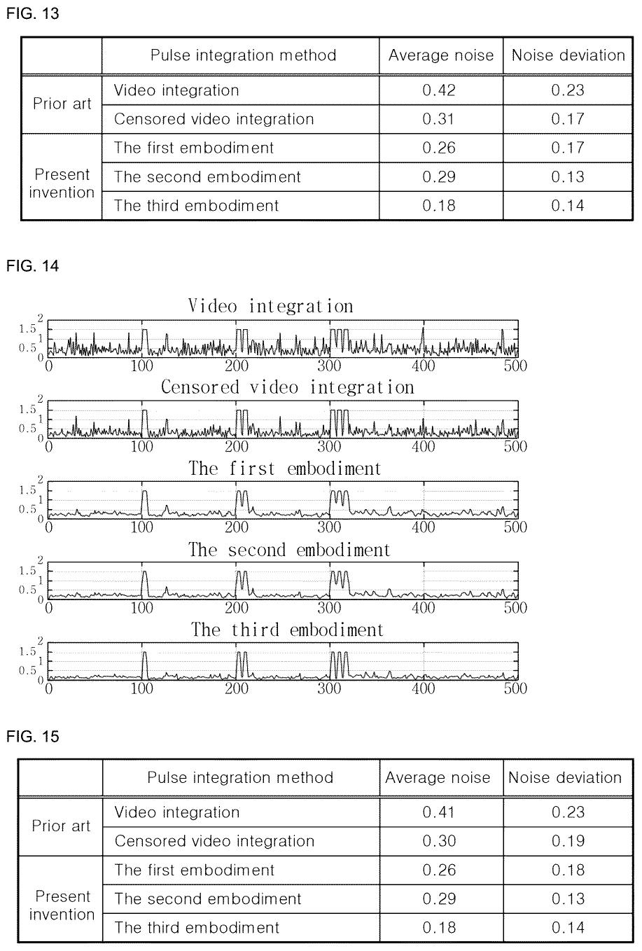

FIG. 12 shows graphs of the pulse integration results of the separated target processed by the two conventional one-dimensional pulse integration methods described in [BACKGROUND] and the three two-dimensional pulse integration methods according to the present invention described above. FIG. 13 is a table showing the mean and standard deviation of the result values showed in FIG. 12.

k=3 is used in the conventional censored method and data extraction during two-dimensional pulse integration according to the present invention is performed for three range bins, one before and after the reference sample that is m=3. Data clamping occurs from the 10th value that is k=10 in the second embodiment, and data clamping occurs from the 6th value that is k=6 and k1=6 in the third embodiment.

FIG. 12 shows that noise spikes are significantly reduced in graphs, which are three below, using two-dimensional pulse integration according to the present invention compared to graphs, which are two above, using conventional one-dimensional pulse integration. The table in FIG. 13 shows that the standard deviation of the two-dimensional pulse integration result according to the present invention is less than the standard deviation of the conventional one-dimensional pulse integration result, thereby increasing the noise spike removal effect. In particular, in the case of the third embodiment of the present invention, the average value is also lower than the result according to the conventional method, thereby demonstrating high performance.

FIG. 14 shows a graph of the pulse integration results of adjacent targets processed by the two conventional one-dimensional pulse integration methods described in [BACKGROUND] and the three two-dimensional pulse integration methods according to the present invention. FIG. 15 is a table showing the mean and standard deviation of the results of FIG. 14.

In the third and fourth graphs of FIG. 14 corresponding to the first and second embodiments of the present invention, it can be seen that two and three adjacent square pulses are clustered together, so that the resolution between adjacent targets is reduced. In the fifth graph corresponding to the third embodiment of the present invention, it can be seen that the target resolution is improved because the valleys between two and three adjacent square pulses are deep.

The third embodiment of the two-dimensional pulse integration method according to the present invention shows improved performance compared to the prior art in both SNR and noise spike improvement, and resolution.

### EXPLANATION OF DRAWING SYMBOLS

S10 A reference data extraction step

S16 A first reference data extraction step

S17 A second reference data extraction step

S20 A data sorting step

S26 A first data sorting step

S27 A second data sorting step

S30 A replacement step

S31 An erasing step

S36 A first replacement step

S38 A second replacement step

S40 An integration step

S46 A first integration step

S47 A second integration step

S50 A minimum value selection step

1. A two-dimensional pulse integration method comprising:
a reference data extraction step of extracting m×N pieces of reference data for each azimuth of m consecutive range bins, including the pth range bin, for the pth pulse integral of the received radar signal;
a data sorting step of sorting the extracted m×N reference data in ascending order of size;
a replacement step of replacing all reference data after the kth reference data among the sorted reference data with the kth reference data value; and
an integration step of summing all the reference data values after a replacement step according to [Equation 3], wherein N is the number of azimuth divisions and m is the number of range bins included in the pulse integration.
$$y = \frac{{\sum }_{j = 1}^{k} {x}_{j} + ( mN - k ) {x}_{k}}{mN} \qquad [ Equation 3 ]$$

2. A two-dimensional pulse integration method comprising:
a reference data extraction step of extracting m×N pieces of reference data for each azimuth of m consecutive range bins, including the pth range bin for the pth pulse integral of the received radar signal;
a data sorting step of sorting the extracted m×N reference data in ascending order of size;
an erasing step of erasing the first N1 reference data and the last N2 reference data among the sorted reference data; and
an integration step of summing all the remained reference data values after erasing are performed according to [Equation 4] and [Equation 5].
$${Z}_{j} = ( {N}_{s} - j + 1 ) ( {X}_{N 1 + J} - {X}_{N 1 + j - 1} ) , {N}_{s} = N - N 1 - N 2 \qquad [ Equation 4 ]$$
$$y = \frac{{\sum }_{j = 1}^{Ns} {Z}_{j}}{{N}_{s}} \qquad [ Equation 5 ]$$

3. A two-dimensional pulse integration method comprising:
a first reference data extraction step of extracting m1×N reference data for each azimuth of m1 consecutive range bins that include the pth range bin and are continuous up to the pth range bin for the pth pulse integral of the received radar signal;
a first data sorting step of sorting the extracted m1×N first reference data in ascending order of size;
a first replacement step in which all reference data after the k1th reference data among the sorted reference data are replaced with the k1th reference data value;
a first integration step of summing all the reference data values after replacement;
a second reference data extraction step of extracting m2×N reference data for each azimuth of m2 consecutive range bins that include the pth range bin and continuous from the pth range bin;
a second data sorting step of sorting the extracted m2×N second reference data in ascending order of size;
a second replacement step in which all reference data after the k2th reference data among the sorted reference data are replaced with the k2th reference data value;
a second integration step of summing all the reference data values after replacement, and
a minimum value selection step that adopts the smaller value between the results of the first integration step and the second integration step.
